(19) United States
(12) Patent Application Publication
(10) Pub. No.: US 2023/0104747 A1
(43) Pub. Date: Apr. 6, 2023

(54) ELECTROPHOTOGRAPHIC MEMBER AND ELECTROPHOTOGRAPHIC IMAGE FORMING APPARATUS

(71) Applicant: CANON KABUSHIKI KAISHA, Tokyo (JP)

(72) Inventor: Masahiro Takenaga, Kanagawa (JP)

(21) Appl. No.: 17/818,644

(22) Filed: Aug. 9, 2022

(30) Foreign Application Priority Data
Aug. 13, 2021 (JP) 2021-131871
Jul. 7, 2022 (JP) 2022-109879

(51) Int. Cl. G03G 15/16; C08K 5/19; C08K 5/43; C08K 5/50

(52) U.S. Cl. CPC G03G 15/162; C08K 5/19; C08K 5/43; C08K 5/50

(57) ABSTRACT

An electrophotographic member comprising a base layer and an elastic layer on the base layer. The elastic layer comprises a silicone rubber, at least one first cation selected from the group consisting of a cation of Structural Formula (1-1) and a cation of Structural Formula (1-2), at least one second cation selected from the group consisting of a cation of Structural Formula (2-1) and a cation of Structural Formula (2-2), and an anion.

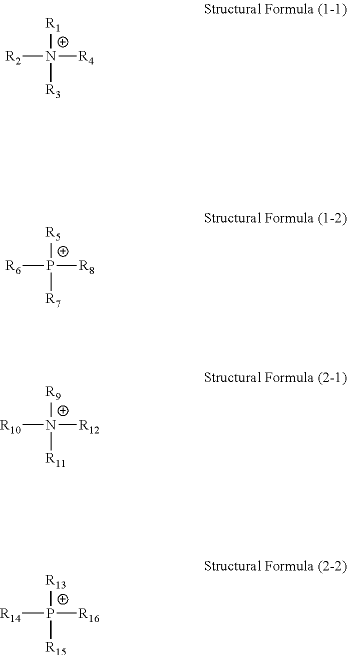

### BACKGROUND

### Technical Field

The present disclosure relates to an electrophotographic member, and an electrophotographic image forming apparatus provided with the electrophotographic member.

### Description of the Related Art

For the electrophotographic image forming apparatus, it is required to be capable of forming a high-quality electrophotographic image even on a thick paper of which the paper weight exceeds 300 g/m² and a recording medium of which the surface is not smooth, such as embossed paper. However, when an electrophotographic image is formed on the surface of the recording medium of which the surface is not smooth, there has been a case where the toner is not sufficiently transferred to a recess portion of the surface. For such a disadvantage, it is effective to use an intermediate transfer belt having an electroconductive elastic layer that contains rubber such as silicone rubber, which is excellent in followability to a surface shape of the recording medium. In addition, as a material that imparts electroconductivity to a resin or rubber, an ion conductive agent having an alkylammonium cation (Japanese Patent Application Laid-Open No. 2013-185140), and an ion conductive agent having an alkyl phosphonium cation (Japanese Patent Application Laid-Open No. 2012-48198) are disclosed.

According to the study of the present inventor, even when ion conductive agents having the alkylammonium cation and the alkyl phosphonium cation (hereinafter, also collectively referred to as “ammonium-based conductive agent”) are each added to the silicone rubber, which are disclosed in Japanese Patent Application Laid-Open No. 2013-185140 and Japanese Patent Application Laid-Open No. 2012-48198, there has been a case where the volume resistivity (hereinafter also referred to as “ρv”) of the elastic layer cannot be sufficiently reduced. On the other hand, an ion conductive agent exists that can reduce the ρv of the elastic layer more than the ammonium-based conductive agent, but is expensive compared to the ammonium-based conductive agent. For this reason, the present inventor has realized that there is a need for development of such a new technology as to be capable of further reducing ρv of the elastic layer at low cost.

### SUMMARY

At least one aspect of the present disclosure is directed to providing an electrophotographic member that can achieve a further reduction of volume resistance value at low cost. In addition, another aspect of the present disclosure is directed to providing an electrophotographic image forming apparatus that can form a high-quality electrophotographic image.

According to one aspect of the present disclosure, there is provided an electrophotographic member including a base layer and an elastic layer on the base layer, wherein the elastic layer includes a silicone rubber, at least one first cation selected from the group consisting of a cation represented by the following Structural Formula (1-1) and a cation represented by the following Structural Formula (1-2), at least one second cation selected from the group consisting of a cation represented by the following Structural Formula (2-1) and a cation represented by the following Structural Formula (2-2), and an anion:

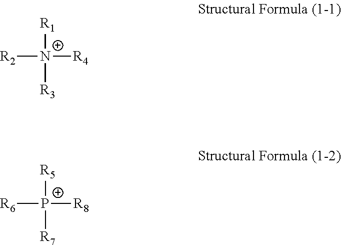

(In Structural Formulae (1-1) and (1-2), R₁ to R₈ each independently represent an alkyl group having 1 to 14 carbon atoms, provided that at least three of the alkyl groups represented by R₁ to R₄ and at least three of the alkyl groups represented by R₅ to R₈ have a straight-chain portion having 6 or more carbon atoms.)

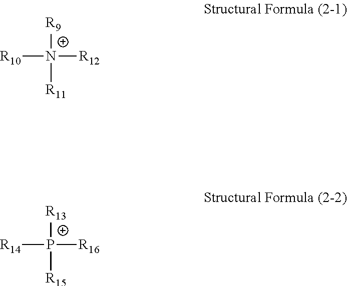

(In Structural Formulae (2-1) to (2-2), R₉ to R₁₆ each independently represent an alkyl group having 1 to 4 carbon atoms.)

In addition, according to another aspect of the present disclosure, there is provided an electrophotographic image forming apparatus including the above electrophotographic member as an intermediate transfer member.

Further features of the present disclosure will become apparent from the following description of exemplary embodiments with reference to the attached drawings.

### BRIEF DESCRIPTION OF THE DRAWINGS

FIG. 1A illustrates a schematic view illustrating a (first) cation-anion aggregate.

FIG. 1B illustrates a schematic view illustrating dissociation of the (first) cation-anion aggregate by an addition of a second cation.

FIG. 2 illustrates a schematic cross-sectional view illustrating one example of a full-color electrophotographic image forming apparatus.

FIG. 3 illustrates a schematic configuration diagram of an electrophotographic member having an endless belt shape according to one aspect of the present disclosure.

### DESCRIPTION OF THE EMBODIMENTS

Preferred embodiments of the present disclosure will now be described in detail in accordance with the accompanying drawings.

The present inventor has assumed the reason why even when the ammonium-based conductive agents according to Japanese Patent Application Laid-Open No. 2013-185140 and Japanese Patent Application Laid-Open No. 2012-48198 are each added to the silicone rubber elastic layer, it is difficult to sufficiently reduce ρv, in the following way. Usually, electroconductivity at the time when an ion conductive agent is added to a resin or rubber is proportional to the product of the number of carrier ions which serve as carriers of electroconductivity and the mobility of ions (ion mobility). For information, the electric resistance is inversely proportional to the product of the number of ions and the ion mobility. The silicone rubber which is nonpolar has low compatibility with the ammonium-based conductive agent which has polarity. Because of this, even when the ammonium-based conductive agent is contained in the silicone rubber, the ammonium-based conductive agent is not easily dissociated into a cation and an anion in the silicone rubber, and forms an aggregate (hereinafter, also referred to as a “cation-anion aggregate”) which is caused by a regular arrangement of cation-anion. Because of this, it is considered that the amount of generated carrier ions becomes insufficient with respect to the amount of the blended ammonium-based conductive agents, and it is difficult to further reduce ρv of the elastic layer.

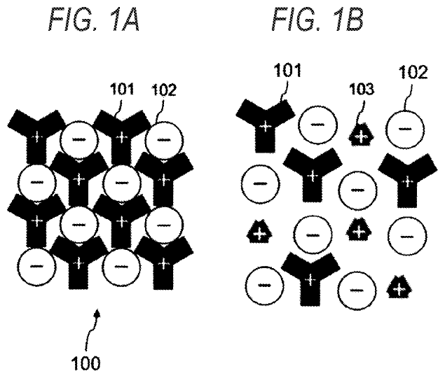

Then, the inventor of the present disclosure has repeatedly studied in order to improve the degree of dissociation between the anion and the cation which constitute the ammonium-based conductive agent in the silicone rubber. As a result, it has been found that the coexistence of two types of ammonium cations having different molecular structures in the silicone rubber is effective in improving the degree of ionic dissociation of the ammonium-based conductive agent in the silicone rubber. In other words, as described above, the ammonium-based conductive agent is considered to constitute an aggregate 100 of a first cation 101 and an anion 102 in the silicone rubber, as illustrated in FIG. 1A. Because of this, the number of carrier ions becomes less, and the effect of improving the electroconductivity of the elastic layer containing silicone rubber is limited. On the other hand, it is considered that coexistence of a second cation 103, which has a molecular structure different from that of the first cation 101, in the silicone rubber as shown in FIG. 1B can hinder the formation of the aggregate 100 caused by the regular arrangement of the first cation and the anion. Specifically, the first cation 101 having three or more alkyl groups (hereinafter, also referred to as “long-chain alkyl group”) including a structure in which six or more carbon atoms are linearly arranged in the silicone rubber, and a second cation 103 having only an alkyl group having 4 or less carbon atoms (hereinafter also referred to as a “short-chain alkyl group”) are allowed to coexist. Here, the first cation having three or more long-chain alkyl groups has a bulky structure extending in three or more directions from a nitrogen atom or a phosphorus atom in the cation, but on the other hand, the second cation having only the short-chain alkyl group is not bulky. In other words, it can be said that these two types of cations have greatly different shapes from each other. Thereby, as is illustrated in FIG. 1B, the aggregate 100 is hindered from being formed by the first cation 101 and the anion 102, and the number of carrier ions can be increased. As a result, it is considered that even in the case where an ammonium-based conductive agent is used, the resistance of the elastic layer can be more reliably reduced. Embodiments of the electrophotographic member according to the present disclosure will be described below in detail. Note that the present disclosure is not limited to the following embodiments.

<Electrophotographic Member>

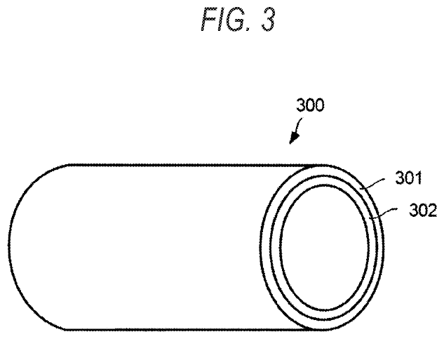

An electrophotographic member according to an aspect of the present disclosure includes a base layer, and an elastic layer on the base layer. The shape of the electrophotographic member is not particularly limited, and can be, for example, a cylindrical shape, a columnar shape or an endless belt shape. FIG. 3 is a schematic configuration diagram of an electrophotographic member 300 having an endless belt shape (hereinafter also referred to as “electrophotographic belt”), according to one aspect of the present disclosure. The belt 300 for electrophotography is formed of a base layer 302 having an endless belt shape, and an elastic layer 301 formed on the outer peripheral surface thereof. For information, if necessary, a surface layer (not illustrated) may be further provided on the outer peripheral surface of the elastic layer 301. It is preferable that the volume resistivity of the electrophotographic member is 1.0×10⁸ to 2.0×10¹¹ Ω·cm. For information, the volume resistivity of the electrophotographic member to which electroconductivity has been imparted by the ion conductive agent increases due to long-term use, in some cases. Because of this, it is more preferable for the volume resistivity in the electrophotographic image forming apparatus before use (immediately after production of the electrophotographic member) to be 1.0×10⁸ to 8.0×10¹⁰ Ω·cm. In addition, it is particularly preferable to be 1.0×10⁸ to 5.0×10¹⁰ Ω·cm.

[Base Layer]

As the base layer, a layer can be used which has a cylindrical shape, a columnar shape or an endless belt shape, corresponding to the shape of the electrophotographic member. A material of the base layer is not particularly limited as long as the material is excellent in heat resistance and a mechanical strength. Examples thereof include: metals such as aluminum, iron, copper and nickel; alloys such as stainless steel and brass; ceramics such as alumina and silicon carbide; and resins such as polyether ether ketone, polyethylene terephthalate, polybutylene naphthalate, polyester, polyimide, polyamide, polyamide imide, polyacetal and polyphenylene sulfide. Note that when a thermosetting resin or a thermoplastic resin is employed as the material of the base layer, an electroconductive powder such as a metal powder, an electroconductive oxide powder or electroconductive carbon may be added to impart electroconductivity. A preferable volume resistivity of the base layer is, for example, 1.0×10⁸ to 1.0×10¹¹ Ω·cm. A preferable surface resistivity of the base layer is, for example, 3.0×10⁹ to 3.0×10¹²Ω/□. As the material of the base layer, resins excellent in flexibility and mechanical strength are particularly preferable, and among the resins, polyether ether ketone which contains carbon black as an electroconductive powder, and polyimide which contains carbon black as the electroconductive powder are particularly preferably used. In addition, the thickness of the base layer having the endless belt shape is, for example, 10 to 500 μm, particularly 30 to 150 μm.

[Elastic Layer]

The elastic layer includes: silicone rubber as a matrix material; and a first cation, a second cation and an anion which are dispersed in the silicone rubber. More specifically, the elastic layer is formed of such a cured product that a silicone rubber mixture is cured which contains at least a raw material of silicone rubber (base polymer, crosslinking agent and the like), a first cation, a second cation and an anion. Many of the silicone rubber mixtures are liquid, and accordingly, it is easy to adjust the elasticity of the elastic layer to be produced, by adjusting the degree of cross-linking, corresponding to the type and amount of the material to be added. The silicone rubber contained in the elastic layer will be described below.

(Silicone Rubber)

The silicone rubber is a cured product that is formed by curing of an addition curing type of liquid silicone rubber. In general, the addition curing type of liquid silicone rubber contains the following components (a), (b) and (c).

(a) An organopolysiloxane having an unsaturated aliphatic group;

(b) an organopolysiloxane having active hydrogen bonded to a silicon atom; and

(c) a platinum compound functioning as a crosslinking catalyst.

Examples of the organopolysiloxane that has the unsaturated aliphatic group which is the above component (a) include the following compounds:
a straight chain organopolysiloxane in which both molecular ends are represented by (R₂₁)₂R₂₂SiO_{1/2} and an intermediate unit is represented by (R₂₁)₂SiO and R₂₁R₂₂SiO; and
a branched organopolysiloxane in which both molecular ends are represented by (R₂₁)₂R₂₂SiO_{1/2} and an intermediate unit includes R₂₁SiO_{3/2} or SiO_{4/2}.

Here, R₂₁ represents an unsubstituted or substituted monovalent hydrocarbon group which is bonded to a silicon atom in the above Formulae and does not contain an unsaturated aliphatic group. Examples of the hydrocarbon group include specifically the following groups:
alkyl groups (for example, methyl group, ethyl group, propyl group, butyl group, pentyl group, and hexyl group); and
aryl groups (phenyl group, naphthyl group and the like).

Examples of a substituent which the hydrocarbon group may have include: halogen atoms such as a fluorine atom and a chlorine atom; alkoxy groups such as a methoxy group and an ethoxy group; and a cyano group. Specific examples of the substituted hydrocarbon group include a chloromethyl group, a 3-chloropropyl group, a 3,3,3-trifluoropropyl group, a 3-cyanopropyl group, and a 3-methoxypropyl group. Among the substituted hydrocarbon groups, it is preferable that 50% or more of R₂₁ is a methyl group, and it is more preferable that all R₂₁ are methyl groups, because synthesis and handling are easy and excellent heat resistance can be obtained.

In addition, R₂₂ represents an unsaturated aliphatic group which is bonded to a silicon atom in the above Formulae. Examples of the unsaturated aliphatic group include a vinyl group, an allyl group, a 3-butenyl group, a 4-pentenyl group, and a 5-hexenyl group. Among the unsaturated aliphatic groups, the vinyl group is preferable because the synthesis and the handling are easy and a cross-linking reaction of the silicone rubber tends to easily proceed.

The organopolysiloxane having the active hydrogen bonded to a silicon atom, which is the above component (b), is a cross-linking agent that reacts with the unsaturated aliphatic group of the component (a) by a catalytic action of the platinum compound which is the component (c), and forms a cross-linked structure. It is preferable that the number of active hydrogen atoms bonded to silicon atoms in the component (b) is a number exceeding three atoms on average in one molecule. Examples of the organic group bonded to the silicon atom in the organopolysiloxane having the active hydrogen bonded to the silicon atom, which is the component (b), include an unsubstituted or substituted monovalent hydrocarbon group that does not contain an unsaturated aliphatic group, which is the same as R₂₁ in the component (a). In particular, a methyl group is preferable as the organic group because the synthesis and the handling are easy.

The molecular weight of the component (b) is not particularly limited. In addition, it is preferable for a viscosity of the component (b) at 25° C. to be 10 to 100,000 mm²/s, and is more preferable to be 15 to 1,000 mm²/s. When the viscosity of the component (b) at 25° C. is within the above range, it does not occur that the organopolysiloxane volatilizes during storage and does not provide a desired degree of cross-linking or desired physical properties of the formed article; and the organopolysiloxane becomes easy to synthesize and handle, and becomes easy to uniformly disperse in the system.

The siloxane skeleton of the component (b) may be any of a straight chain shape, a branched shape and a cyclic shape, and mixtures thereof may be used. In particular, from the viewpoint of ease of synthesis, the siloxane skeleton of the component (b) is preferably a straight chain shape. In addition, in the component (b), an Si—H bond may exist in any siloxane unit in the molecule, but it is preferable that at least a part of the Si—H bonds exists in a siloxane unit at a molecular terminal such as an (R₂₁)₂HSiO_{1/2} unit.

In the addition curing type of liquid silicone rubber, it is preferable for the amount of the unsaturated aliphatic groups to be 0.1 to 2.0 mol % based on 1 mol of silicon atoms, and is more preferable to be 0.2 to 1.0 mol %.

As the above component (c), a known platinum compound can be used.

(First Cation)

The first cation is at least one selected from the group consisting of a cation represented by the following Structural Formula (1-1) and a cation represented by the following Structural Formula (1-2).

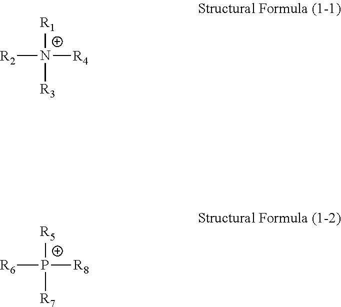

In Structural Formulae (1-1) and (1-2), R₁ to R₈ each independently represent an alkyl group having 1 to 14 carbon atoms. However, at least three of the alkyl groups represented by R₁ to R₄ and at least three of the alkyl groups represented by R₅ to R₈ have a straight-chain portion having 6 or more carbon atoms. Here, the “straight-chain portion having 6 or more carbon atoms” means a structure in which 6 carbon atoms are linearly arranged. In addition, an alkyl group “having a straight-chain portion having 6 or more carbon atoms” means an alkyl group having 6 to 14 carbon atoms including the straight-chain portion.

The alkyl groups represented by R₁ to R₄ in Structural Formula (1-1) and R₅ to R₈ in Structural Formula (1-2) may have a straight-chain structure or a branched structure. In addition, R₁ to R₄ may be all the same, or may be all different from each other. However, it is preferable that all of R₁ to R₄ are not the same alkyl group. Specifically, it is preferable that at least one of the substituents selected from R₁ to R₄ is an alkyl group different from the other substituents. Specifically, for example, it is preferable that R₁ to R₃ are the same alkyl groups, and R₄ is an alkyl group different from R₁ to R₃. With R₁ to R₄ not being the same alkyl groups, the structural symmetry of the cation is lowered, and the dissociation property between the first cation and the anion can be further enhanced. As a result, such an effect is more enhanced that the second cation prevents the formation of a first cation-anion aggregate. Also as for R₅ to R₈, similarly to the above, the alkyl groups may be all the same, or may be all different from each other, but it is preferable that all the alkyl groups are not same. Specifically, it is preferable that at least one of the substituents selected from R₅ to R₈ is an alkyl group different from the other substituents.

In addition, all four of R₁ to R₄ may be long-chain alkyl groups having a straight-chain portion having 6 or more carbon atoms. However, when all of the four alkyl groups are long-chain alkyl groups, adjacent alkyl chains are oriented and stabilized, and accordingly there is a case where ion dissociation is hindered from being accelerated when the second cation is added. Because of this, it is preferable that three of R₁ to R₄ have a straight-chain portion having 6 or more carbon atoms, and the other one does not have a straight-chain portion having 6 or more carbon atoms. Also, as for R₅ to R₈, similarly to the above, all four substituents may be long-chain alkyl groups having a straight-chain portion having 6 or more carbon atoms. However, it is preferable that three of R₅ to R₈ have a straight-chain portion having 6 or more carbon atoms, and the other one does not have a straight-chain portion having 6 or more carbon atoms. Note that the alkyl group “which does not have a straight-chain portion having 6 or more carbon atoms” means an alkyl group having 5 or less carbon atoms, or in the case of being an alkyl group having 6 to 14 carbon atoms, an alkyl group in which number of carbon atoms in a straight-chain portion in the alkyl group is 5 or less. Examples of the first cation represented by Structural Formula (1-1) include, for example, methyltri-n-hexyl ammonium ion, methyltri-n-octyl ammonium ion, methyltridecyl ammonium ion, methyltritetradecyl ammonium ion, tri-n-hexylbutyl ammonium ion, tri-n-hexyl-n-octyl ammonium ion, tri-n-hexyltetradecyl ammonium ion, and tetra-n-octyl ammonium ion. Among them, in order that three of R₁ to R₄ have a straight-chain portion having 6 or more carbon atoms and the other one does not have a straight-chain portion having 6 or more carbon atoms, methyltri-n-hexyl ammonium ion, methyltri-n-octyl ammonium ion, methyltridecyl ammonium ion, methyltritetradecyl ammonium ion, and tri-n-hexylbutyl ammonium ion are particularly preferable. Examples of the first cation represented by Structural Formula (1-2) include, for example, methyltri-n-hexyl phosphonium ion, methyltri-n-octyl phosphonium ion, methyltridecyl phosphonium ion, methyltritetradecyl phosphonium ion, tri-n-hexylbutyl phosphonium ion, tri-n-hexyl-n-octyl phosphonium ion, tri-n-hexyltetradecyl phosphonium ion, and tetra-n-octyl phosphonium ion.

(Second Cation)

The second cation is at least one selected from the group consisting of a cation represented by the following Structural Formula (2-1) and a cation represented by the Structural Formula (2-2).

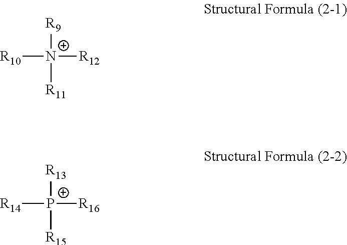

In Structural Formula (2-1), R₉ to R₁₂ are each independently an alkyl group having 1 to 4 carbon atoms. In addition, in Structural Formula (2-2), R₁₃ to R₁₆ are each independently an alkyl group having 1 to 4 carbon atoms. R₉ to R₁₆ may have a straight-chain structure or a branched structure. Examples of the cation represented by the above Structural Formula (2-1) include, for example, ethyltrimethyl ammonium ion, triethylmethyl ammonium ion, trimethyl-n-propyl ammonium ion, trimethyl-n-butyl ammonium ion, tri-n-butylmethyl ammonium ion, tert-butyltrimethyl ammonium ion, tetraethyl ammonium ion, tetra-n-propyl ammonium ion, and tetra-n-butyl ammonium ion. Among them, ethyltrimethyl ammonium ion, triethylmethyl ammonium ion, trimethyl-n-propyl ammonium ion, trimethyl-n-butyl ammonium ion, tri-n-butylmethyl ammonium ion and tert-butyltrimethyl ammonium ion, in which all of R₉ to R₁₂ are not the same alkyl groups, are particularly preferable. Examples of the cation represented by the above Structural Formula (2-2) include, for example, ethyltrimethyl phosphonium ion, triethylmethyl phosphonium ion, trimethyl-n-propyl phosphonium ion, trimethyl-n-butyl phosphonium ion, tri-n-butylmethyl phosphonium ion, tert-butyltrimethyl phosphonium ion, tetraethyl phosphonium ion, tetra-n-propyl phosphonium ion, and tetra-n-butyl phosphonium ion. Among them, ethyltrimethyl phosphonium ion, triethylmethyl phosphonium ion, trimethyl-n-propyl phosphonium ion, trimethyl-n-butyl phosphonium ion, tri-n-butylmethyl phosphonium ion, and tert-butyltrimethyl phosphonium ion, in which all of R₁₃ to R₁₆ are not the same alkyl groups, are particularly preferable.

Regarding the quantity ratio between the first cation and the second cation, it is preferable that X/(X+Y) is 0.2 to 0.7, where X represents the number of moles of the first cation and Y represents the number of moles of the second cation. With the quantity ratio being controlled to such a range, the formation of the first cation-anion aggregate can be more reliably prevented.

Note that when two or more of the above first cations and the above second cations are used in combination, the number of moles X of the above first cations and the number of moles Y of the above second cations mean the total number of moles of the plurality of first cations and the plurality of second cations, respectively. In addition, the elastic layer may contain a cation other than the above first and second cations. For example, a cation which is modified with a dimethyl siloxane chain has a chemical structure similar to that of the curable silicone rubber and has a high affinity for the curable silicone rubber. Because of this, when the elastic layer contains the cation which is modified with the dimethyl siloxane chain, the electrophotographic member exhibits more uniform volume resistivity.

(Anion)

The anion is not particularly limited. Specific examples of the anion are given below.

F⁻, Cl⁻, Br⁻, I⁻, AlCl₄⁻, NO₃⁻, BF₄⁻, PF₆⁻, AsF₆⁻, SbF₆⁻, CH₃COO⁻, CF₃COO⁻, (C₂F₅)₃PF₃⁻, CₙF₂ₙ₊₁SO₃⁻, and (CₘF₂ₘ₊₁SO₂)(CₙF₂ₙ₊₁SO₂)N⁻. Here, m and n each independently represent an integer of 0 or more. The upper limits of m and n are not particularly limited, and are each preferably 4 or less from the viewpoint of ensuring satisfactory mobility of the anion. In other words, it is preferable that m and n each independently represent an integer of 0 to 4. The anions described above may be used alone, or two or more types thereof may be used in combination. In addition, among the anions represented by (CₘF₂ₘ₊₁SO₂) (CₙF₂ₙ₊₁SO₂)N⁻, an anion in which both m and n are 1 or more is preferable, because the anion is highly hydrophobic and the mobility is less likely to be affected by humidity. Furthermore, among the anions, an anion represented by the following Structural Formula (3) is more preferable. This is because when the size of the anion is small, the ion mobility is high, which is advantageous for lowering the resistance of the elastic layer.

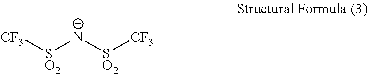 [SMILES: O=S(=O)([N-]S(=O)(=O)C(F)(F)F)C(F)(F)F]

The presence of the above first cation, the second cation and the anion in the elastic layer can be confirmed by an operation of immersing the elastic layer in a solvent such as methanol or methyl ethyl ketone (MEK), extracting the components which have eluted into the solvent, and analyzing the components. Examples of the analysis method include liquid chromatographic mass spectrometry and nuclear magnetic resonance spectroscopy.

It is preferable that the total amount of the first cation and the second cation is preferably 0.3 to 18 mmol based on 100 g of the silicone rubber in the elastic layer. With the total amount of the first cation and the second cation based on the silicone rubber in the elastic layer being controlled to the above range, it becomes easy to adjust the volume resistivity of the elastic layer so as to become within a range of a semiconductive region. Here, the volume resistivity of the elastic layer is adjusted by the amounts of the first and second cations and anions to be added, the ratio of the first cation to the second cation, the amount of a filler to be added which will be described later, and the like. When the base layer is electroconductive as described above, the ratio of the volume resistivity of the elastic layer to that of the base layer (volume resistivity of the elastic layer/volume resistivity of the base layer) is preferably 0.01 to 100. For information, the semiconductive region in terms of volume resistivity is in a range of 1.0×10⁸ to 2.0×10¹¹ Ω·cm.

(Additive)

The elastic layer according to the present disclosure may contain an additive such as a filler, a coloring agent, a crosslinking accelerator, a crosslinking retarder, a crosslinking aid, a scorch retarder, an antiaging agent, a softening agent, a heat stabilizer, a capture agent, a flame retardant, a flame retardant aid, an ultraviolet absorber, a rust-preventive agent, and an electron conductive agent, to the extent that the effects according to the present aspect are not impaired.

Examples of the filler include reinforcing fillers such as fumed silica, crystalline silica, wet silica, fumed titanium oxide and cellulose nanofiber. The surface of the reinforcing filler may be modified with an organosilicon compound such as an organoalkoxysilane, an organohalosilane, an organosilazane, a diorganosiloxane oligomer in which both ends of the molecular chain are blocked with silanol groups, or a cyclic organosiloxane, in order that the reinforcing filler becomes easily dispersed in the silicone rubber. Among the fillers, hydrophilic silica can be suitably used, because of being capable of significantly adjusting the viscosity of an addition curing type liquid silicone rubber mixture for forming the elastic layer. Here, the hydrophilic silica specifically refers to silica having a pH value of 7.0 or lower, in particular, 3.5 to 5.0. Examples of such hydrophilic silica include “AEROSIL 90” (pH value: 3.7 to 4.7), “AEROSIL 130” (pH value: 3.7 to 4.5), “AEROSIL 150” (pH value: 3.7 to 4.5), “AEROSIL 200” (pH value: 3.7 to 4.5), “AEROSIL 255” (pH value: 3.7 to 4.5), “AEROSIL 300” (pH value: 3.7 to 4.5), and “AEROSIL 380” (pH value: 3.7 to 4.5) (which are all trade names), which are produced by Nippon Aerosil Co., Ltd.

Examples of the electron conductive agent include: electroconductive carbon black such as acetylene black and Ketchen black; graphite, graphene, carbon fibers and carbon nanotubes; powders of metals such as silver, copper and nickel; and electroconductive zinc oxide, electroconductive calcium carbonate, electroconductive titanium oxide, electroconductive tin oxide, and electroconductive mica. However, when the electron conductive agent is contained in the elastic layer according to the present embodiment, the voltage dependence of the elastic layer tends to become large, and accordingly, it is preferable that the elastic layer does not contain the electron conductive agent, or, even though containing, contains in such an amount that the electron conductive agent does not express electron conductivity. As the other additives, known additives can be appropriately selected and used.

It is preferable for the hardness of the elastic layer to be 20 to 80 degrees in the type A hardness, and is more preferable to be 45 to 80 degrees. In addition, in consideration of a mechanical strength and flexibility, it is preferable for the thickness of the elastic layer to be 50 to 500 μm, and is more preferable to be 100 to 400 μm. A primer may be appropriately applied to the outer surface of the base layer, so as to more firmly bond the base layer and the elastic layer. The primer to be used here is a paint in which a silane coupling agent, a silicone polymer, a hydrogenated methyl siloxane, an alkoxysilane, a reaction promoting catalyst and a coloring agent such as bengara are appropriately blended and dispersed in an organic solvent. As the primer, a commercially available product can be used. Primer treatment is performed by applying this primer to the outer surface of the base layer, and drying or firing the primer. The primer can be appropriately selected according to the material of the base layer, the type of the elastic layer, or the form of the cross-linking reaction. In particular, when the elastic layer contains a large amount of unsaturated aliphatic groups, a primer containing a hydrosilyl group is preferably used, so as to impart adhesiveness to the elastic layer by reaction with the unsaturated aliphatic groups. Examples of commercially available primers having such characteristics include DY39-051A/B (trade name, and produced by Dow Corning Toray Co., Ltd.). When the elastic layer contains a large amount of hydrosilyl groups, a primer containing an unsaturated aliphatic group is preferably used. Examples of commercially available primers having such characteristics include DY39-067 (trade name, and produced by Dow Corning Toray Co., Ltd.). Examples of primers also include primers containing alkoxy groups. In addition, surface treatment such as ultraviolet irradiation, to which the surface of the base layer is subjected, can assist the cross-linking reaction between the base layer and the elastic layer, and can further enhance the adhesive strength. Examples of primers other than those described above include: X-33-156-20, X-33-173A/B, X-33-183A/B (which are all trade names and are produced by Shin-Etsu Chemical Co., Ltd.); and DY39-90A/B, DY39-110A/B, DY39-125A/B, and DY39-200A/B (which are all trade names and are produced by Dow Corning Toray Co., Ltd.).

[Surface Layer]

A surface layer of the electrophotographic member is required to have resistance to abrasion caused by rubbing with a recording medium such as paper or various abutting members such as a drum, and to have low adhesiveness so that the toner and the like do not adhere thereto. A resin to be used for the surface layer is not particularly limited as long as the resin has the low adhesiveness, and examples thereof include a fluororesin, a fluorine-containing urethane resin, fluororubber, and siloxane-modified polyimide. The surface layer for an intermediate transfer belt is preferably formed from a fluorine-containing urethane resin among the above resins, from the viewpoint of not impairing the elastic function of the elastic layer. A thickness of the surface layer is preferably 0.5 to 20 μm, and is more preferably 1 to 10 When the thickness of the surface layer is 0.5 μm or larger, it becomes easy for the surface layer to suppress the disappearance of the toner due to its abrasion during use. In addition, when the thickness of the surface layer is 20 μm or smaller, the surface layer does not disturb an elastic function of the elastic layer. The surface layer may contain the above described electron conductive agent, if necessary. It is preferable that the content of the electron conductive agent in the surface layer is 30 parts by mass or less based on 100 parts by mass of the surface layer, from the viewpoints of the adhesiveness and a mechanical strength. In addition, if necessary, a primer layer may be provided between the elastic layer and the surface layer. It is preferable for the thickness of the primer layer to be 0.1 to 15 μm, and is more preferable to be 0.5 to 10 μm, from the viewpoint of not disturbing the elastic function.

<Electrophotographic Image Forming Apparatus>

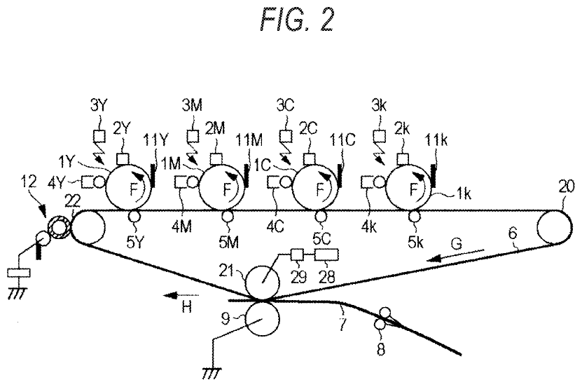

The electrophotographic image forming apparatus according to one aspect of the present disclosure includes the above electrophotographic member according to the present disclosure, as an intermediate transfer member (intermediate transfer belt). One example of embodiments of the electrophotographic image forming apparatus will be described with reference to FIG. 2. The electrophotographic image forming apparatus according to the present embodiment has a so-called tandem structure in which image forming stations of a plurality of colors are arranged side by side in a rotational direction of an endless electrophotographic belt (hereinafter referred to as “intermediate transfer belt”). In the following description, suffixes Y, M, C and k are appended to the symbols of the structures related to the colors of yellow, magenta, cyan and black, respectively, but the suffix is omitted regarding the same structure, in some cases.

In FIG. 2, reference numerals 1Y, 1M, 1C and 1k denote photosensitive drums (photosensitive members, or image carrying bodies). Around the photosensitive drums 1, charging apparatuses 2Y, 2M, 2C and 2k, exposure apparatuses 3Y, 3M, 3C and 3k, developing apparatuses 4Y, 4M, 4C and 4k, respectively, and an intermediate transfer belt (intermediate transfer body) 6 are arranged. The photosensitive drums 1 are each rotationally driven at a predetermined peripheral speed (process speed) in the direction of the arrow F. The charging apparatuses 2 charge the peripheral surfaces of the photosensitive drums 1 to a predetermined polarity and potential (primary charging), respectively. The laser beam scanner as the exposure apparatus 3 outputs laser light which has been on/off modulated so as to correspond to image information that is input from an external device such as an unillustrated image scanner and an unillustrated computer, and scans and exposes the charged surface on the photosensitive drum 1 with light. By this scanning exposure, an electrostatic latent image corresponding to target image information is formed on the surface of the photosensitive drum 1.

The developing apparatuses 4Y, 4M, 4C and 4k contain toners of color components of yellow (Y), magenta (M), cyan (C) and black (k), respectively. Then, the developing apparatuses 4 to be used are selected based on the image information, a developer (toner) is developed on the photosensitive drum 1, and the electrostatic latent image is visualized as a toner image. In the present embodiment, a reverse development system is used which makes the toner adhere to the exposed portion of the electrostatic latent image in this way and develops the electrostatic latent image. In addition, the charging apparatus, the exposure apparatus and the developing apparatus constitute the image forming unit, in this way.

In addition, an intermediate transfer belt 6 is an endless electrophotographic belt according to the present disclosure; and is arranged so as to abut on the respective surfaces of the photosensitive drums 1, and is stretched over a plurality of stretching rollers 20, 21 and 22. In addition, the intermediate transfer belt 6 is structured to rotate in the direction of the arrow G. In the present embodiment, the stretching roller 20 is a tension roller structured to control the tension of the intermediate transfer belt 6 so as to be constant; the stretching roller 22 is a driving roller of the intermediate transfer belt 6; and the stretching roller 21 is a counter roller for secondary transfer. In addition, primary transfer rollers 5Y, 5M, 5C and 5k are arranged on primary transfer positions, which face the photosensitive drums 1, respectively, while sandwiching the intermediate transfer belt 6 therebetween. Unfixed toner images of the colors, which have been formed on the photosensitive drums 1, respectively, are sequentially and electrostatically primary-transferred onto the intermediate transfer belt 6, by a primary transfer bias having a polarity opposite to the charging polarity of the toner (for example, positive polarity), which is applied to the primary transfer rollers 5 by a constant voltage source or a constant current source. Then, a full-color image is obtained in which unfixed toner images of four colors are superimposed on the intermediate transfer belt 6. The intermediate transfer belt 6 rotates while carrying the toner images which have been transferred thereonto from the photosensitive drums 1, in this way. At every one rotation of the photosensitive drums 1 after the primary transfer, the transfer residual toners on the surfaces of the photosensitive drums 1 are cleaned by cleaning apparatuses 11Y, 11M, 11C and 11k, respectively, and the resultant surfaces repeatedly enter the image forming process.

In addition, at the secondary transfer position of the intermediate transfer belt 6, which faces the conveyance path of the recording material 7, a secondary transfer roller (transfer portion) 9 is press-contacted and arranged at the toner image carrying surface side of the intermediate transfer belt 6. In addition, on the back surface side of the intermediate transfer belt 6 at the secondary transfer position, the counter roller 21 which forms a counter electrode of the secondary transfer roller 9 and to which a bias is applied is disposed. When the toner image on the intermediate transfer belt 6 is transferred to the recording material 7, a bias having the same polarity as that of the toner is applied to the counter roller 21 by a secondary transfer bias application unit 28. To the counter roller 21, −1000 to −3000 V is applied, for example, and a current of −10 to −50 μA flows. A transfer voltage at this time is detected by a transfer voltage detecting unit 29. Furthermore, a cleaning apparatus (belt cleaner) 12 for removing the toner which remains on the intermediate transfer belt 6 after the secondary transfer is provided on the downstream side of the secondary transfer position. The recording material 7 which has been introduced from the resist roller pair 8 into the secondary transfer position is nipped at the secondary transfer position and is conveyed; and at this time, a constant voltage bias (transfer bias) that is controlled to a predetermined voltage is applied to the counter roller 21 of the secondary transfer roller 9 from the secondary transfer bias application unit 28. Due to the transfer bias having the same polarity as that of the toner, which has been applied to the counter roller 21, a full-color image (toner image) of four colors that are superposed on the intermediate transfer belt 6 is transferred to the recording material 7 at the transfer portion at a time, and a full-color unfixed toner image is formed on the recording material. The recording material 7 on which the toner image has been transferred is conveyed from the secondary transfer position in the direction of the arrow H, is introduced into an unillustrated fixing device, and is heated there; and the toner image is fixed.

According to one aspect of the present disclosure, an electrophotographic member can be obtained that can achieve a further reduction of volume resistance value at low cost. In addition, according to another aspect of the present disclosure, an electrophotographic image forming apparatus can be obtained that can form a high-quality electrophotographic image.

### EXAMPLES

Ion conductive agents used in Examples and Comparative Examples are shown in the following Table 1.

TABLE 1

| Naming | Name | Structural Formula |
|---|---|---|
| Ammonium 1 | Methyltri-n-octylammonium- bis(trifluoromethanesulfonyl) imide (trade name: MTOA-TFSI, produced by Toyo Gosei Co., Ltd.) | 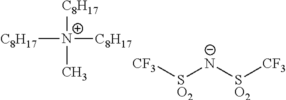 |
| Ammonium 2 | Tri-n-butylmethylammonium- bis(trifluoromethanesulfonyl) imide (trade name: FC-4400, produced by 3M Japan Ltd.) | 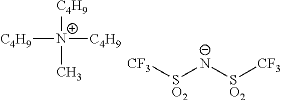 |
| Ammonium 3 | Trimethyl-n-propylammonium- bis(trifluoromethanesulfonyl) imide (produced by Fuji Film Wako Pure Chemical Corporation) | 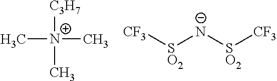 |
| Ammonium 4 | Tetraethylammonium-chloride (produced by Tokyo Chemical Industry Co., Ltd.) | 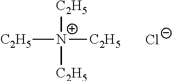 |
| Phosphonium 1 | Tri-n-hexyltetradecylphosphonium- bis(trifluoromethanesulfonyl) imide (produced by Sigma-Aldrich Co., LLC) | 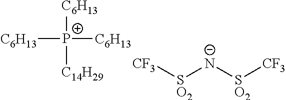 |
| Phosphonium 2 | Tri-n-butylmethylphosphonium- bis(trifluoromethanesulfonyl) imide (produced by Fuji Film Wako Pure Chemical Corporation) | 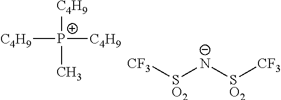 |

<Production of Electrophotographic Belt>

### Example 1-1

(Formation of Base Layer)

The following materials were each charged into a twin-screw kneading machine (trade name: PCM30, manufactured by Ikegai Corp.) with the use of a weight type feeder, and were kneaded. As for a preset temperature of a cylinder of the twin-screw kneading machine, a material charging portion was set at 320° C., and the downstream side of the cylinder and the die were set at 360° C. The number of rotations of the screw of the twin-screw kneading machine was set at 300 rpm, and the amount of material to be supplied was set at 8 kg/h. The obtained kneaded product was cut, and resin pellets were prepared.
Polyetheretherketone (trade name: VICTREXPEEK 450G, produced by Victrex plc.): 75 parts by mass
Acetylene black (trade name: Denka Black granular product, produced by Denka Company Limited): 25 parts by mass

Next, the obtained resin pellet was subjected to cylindrical extrusion, and thereby, a base layer having an endless belt shape was produced. For information, for the cylindrical extrusion, a cylindrical extrusion apparatus was used in which a cylindrical die having a ring-shaped opening with a diameter of 300 mm and a gap of 1 mm was attached to the tip of a single-screw extruder (trade name: GT40, manufactured by Research Laboratory of Plastics Technology Co., Ltd.). Specifically, the resin pellet was supplied to the single-screw extruder at a supply quantity of 4 kg/h with the use of a weight type feeder. As for a preset temperature of the cylinder of the single-screw extruder, a material charging portion was set at 320° C., and the downstream side of the cylinder and the cylindrical die were set at 380° C. A resin tube which was extruded from the cylindrical die was drawn by a cylindrical drawing machine so that the thickness became 60 μm. The resin tube was brought into contact with a cooling mandrel which was provided between the cylindrical die and the cylindrical drawing machine, in the drawing process, and thereby was cooled and solidified. The solidified resin tube was cut by a cylindrical cutting machine which was installed at a lower part of the cylindrical drawing machine so that the length (width) in the direction orthogonal to the circumferential direction became 400 mm. Thus, the base layer having the endless belt shape according to the present example was produced. The volume resistivity of the base layer thus obtained was 1.0×10⁹ Ω·cm. For information, the volume resistivity of the base layer was measured in the same method as in the measurement of the volume resistivity of the electrophotographic belt, which will be described later.

(Formation of Elastic Layer)

To 100 parts by mass of an addition curing type of liquid silicone rubber (trade name: TSE3450 A/B, produced by Momentive Performance Materials Inc.), 5.2 parts by mass of ammonium 1 (8.0 mmol based on 100 g of silicone rubber) and 0.76 parts by mass of ammonium 3 (2.0 mmol based on 100 g of silicone rubber) were added as the ion conductive agent, and the mixture was mixed. Next, 3.0 parts by mass of hydrophilic silica (trade name: AEROSIL380, produced by Nippon Aerosil Co., Ltd.) and 1.0 part by mass of black coloring agent (trade name: LIMS Color 02, produced by Shin-Etsu Chemical Co., Ltd.) were added thereto. After that, the mixture was stirred and defoamed with the use of a planetary stirring defoaming apparatus (trade name: HM-500, manufactured by Keyence Corporation), and an addition curing type of liquid silicone rubber mixture was obtained. Subsequently, the outer surface of the above base layer was subjected to ultraviolet irradiation treatment; and then a primer (trade name: DY39-051, produced by Dow Corning Toray Co., Ltd.) was applied thereonto, and was dried by heating. The base layer having a primer layer formed on the outer surface thereof was attached to a cylindrical core, and a ring nozzle for discharging rubber was further attached to the same axis as that of the core. The above addition curing type of liquid silicone rubber mixture was supplied to the ring nozzle with the use of a liquid feed pump, and was discharged through a slit, and thereby a layer of the addition curing type of liquid silicone rubber mixture was formed on the base layer. At this time, the relative movement speed and the discharge amount of the liquid feed pump were adjusted so that a thickness of the elastic layer after curing became 280 μm. The product was charged into a heating furnace in the state of being attached to the core, and was heated at 130° C. for 15 minutes and further at 180° C. for 60 minutes; and thereby the layer of the addition curing type of liquid silicone rubber mixture was cured, and the elastic layer was formed.

(Formation of Surface Layer)

A fluorine-containing polyurethane resin liquid (trade name: Emralon T-861, produced by Henkel Japan Ltd.) was prepared in which polytetrafluoroethylene was dispersed in a polyurethane dispersion. Next, the outer surface of the elastic layer was subjected to hydrophilic treatment by excimer UV irradiation. After that, the base layer on the surface of which the elastic layer is formed, was fitted over a core, and the polyurethane resin liquid was applied to the elastic layer with the use of a spray gun (trade name: W-101, manufactured by ANEST IWATA Corporation) while the elastic layer was rotated at 200 rpm to form a coated film of the polyurethane resin liquid on the elastic layer. Then, the base layer of which the coated film was formed on the elastic layer was placed in a heating furnace at 130° C. in such a state that the base layer was attached to the core, and the coated film was cured for 30 minutes to form the surface layer. Thus, an electrophotographic belt was obtained that comprises the base layer, the elastic layer on the outer surface of the base layer, and the surface layer having a thickness of 3 μm on the outer surface of the elastic layer.

(Identification of Ammonium 1 and Ammonium 3 in Elastic Layer)

Ammonium 1 and ammonium 3 contained in the elastic layer of the electrophotographic belt, which was produced in the above description, were identified by the following method. 200 mg of a sample was cut out from the elastic layer of the electrophotographic belt, and the sample was immersed in 1 mL of methanol. Then ultrasonic waves of 40 kHz were applied to the methanol containing the sample for 10 minutes. Thereafter, the methanol containing the sample was centrifuged at 12000 rpm for 10 minutes with the use of a high-speed centrifugal separator 7780 (manufactured by Kubota Corporation); and the supernatant was separately collected, and thereby a cation-anion extracted liquid was prepared. Subsequently, the cation-anion extracted liquid was subjected to mass spectrometry with the use of a liquid chromatograph-mass spectrometer (Thermo Scientific LTQ Orbitrap XL, manufactured by Thermo Fisher Scientific) under the following conditions.

[Mass Spectrometry Conditions]
Direct introduction method
Injected quantity: 2 μL
Ionization method: electrospray ionization (ESI)

As a result of the mass spectrometry, it was confirmed that peaks existed at positions of the molecular weights of two types of cations between two types of ion conductive agents (ammonium 1 and ammonium 3) and one type of anion, which were all used at the time of production of the elastic layer. In addition, after the methanol solvent was removed from the cation-anion extracted liquid, the extracted liquid was redissolved in deuterated methanol. The obtained solution was measured with ¹H-NMR (trade name: AL400 type FT-NMR, manufactured by JEOL Ltd.).

[Measurement Conditions]
Frequency: 400 MHz
Number of integration times: 32 times
Measurement temperature: 25° C.

The obtained spectral peaks were attributed to protons of a cation structure of the ammonium 1 and a cation structure of the ammonium 3. From the above, the ammonium 1 and the ammonium 3 contained in the elastic layer were identified.

### Examples 1-2 to 8, and Reference Examples 1-1 to 8-3

Electrophotographic belts according to Examples 1-2 to 8 and Reference Examples 1-1 to 8-3 were obtained in the same way as in Example 1-1, except that the types and compositions of the ion conductive agents to be used were changed as described in the following Tables 2-1 to 2-5. For information, the unit of the numerical values in the Tables is the number of mmol of each ion conductive agent based on 100 g of the silicone rubber.

TABLE 2-1

| | | | | | | Reference | Reference |
|---|---|---|---|---|---|---|---|
| Ion conductive | Example | Example | Example | Example | Example | Example | Example |
| agent | 1-1 | 1-2 | 1-3 | 1-4 | 1-5 | 1-1 | 1-2 |
| Ammonium 1 | 8.0 | 6.7 | 5.0 | 3.3 | 2.0 | 10.0 | — |
| Ammonium 3 | 2.0 | 3.3 | 5.0 | 6.7 | 8.0 | — | 10.0 |

TABLE 2-2

| | | | | Reference | Reference | | Reference | Reference |
|---|---|---|---|---|---|---|---|---|
| Ion conductive | Example | Example | Example | Example | Example | Example | Example | Example |
| agent | 2-1 | 2-2 | 2-3 | 2-1 | 2-2 | 3 | 3-1 | 3-2 |
| Ammonium 1 | 6.7 | 5.0 | 3.3 | 10.0 | — | 6.7 | 10.0 | — |
| Ammonium 2 | 3.3 | 5.0 | 6.7 | — | 10.0 | — | — | — |
| Phosphonium | — | — | — | — | — | 3.3 | — | 10.0 |
| 2 | | | | | | | | |

TABLE 2-3

| | | Reference | Reference | | Reference | Reference |
|---|---|---|---|---|---|---|
| | Example | Example | Example | Example | Example | Example |
| Ion conductive agent | 4 | 4-1 | 4-2 | 5 | 5-1 | 5-2 |
| Ammonium 1 | — | — | — | 5.0 | 10.0 | — |
| Phosphonium 1 | 3.3 | 10.0 | — | — | — | — |
| Ammonium 4 | — | — | — | 5.0 | — | 10.0 |
| Phosphonium 2 | 6.7 | — | 10.0 | — | — | — |

TABLE 2-4

| | | | Reference | Reference | | | Reference | Reference |
|---|---|---|---|---|---|---|---|---|
| Ion conductive | Example | Example | Example | Example | Example | Example | Example | Example |
| agent | 6-1 | 6-2 | 6-1 | 6-2 | 7-1 | 7-2 | 7-1 | 7-2 |
| Ammonium 1 | 0.15 | 0.10 | 0.30 | — | 12.0 | 6.0 | 18.0 | — |
| Ammonium 2 | — | — | — | — | 6.0 | 12.0 | — | 18.0 |
| Ammonium 3 | 0.15 | 0.20 | — | 0.30 | — | — | — | — |

TABLE 2-5

| | | Reference | Reference | Reference |
|---|---|---|---|---|
| Ion conductive | Example | Example | Example | Example |
| agent | 8 | 8-1 | 8-2 | 8-3 |
| Ammonium 1 | 1.0 | 3.0 | — | — |
| Ammonium 2 | 1.0 | — | 3.0 | — |
| Ammonium 3 | 1.0 | — | — | 3.0 |

### Comparative Example 1, and Reference Examples 9-1 and 9-2

Electrophotographic belts according to Comparative Example 1 and Reference Examples 9-1 and 9-2 were obtained in the same manner as in Example 1-1, except that the types and compositions of the ion conductive agents to be used were changed as described in the following Table 2-6. For information, the unit of the numerical values in the Table is the number of mmol of each ion conductive agent based on 100 g of the silicone rubber.

TABLE 2-6

| | | Reference | Reference |
|---|---|---|---|
| Ion conductive | Comparative | Example | Example |
| agent | Example 1 | 9-1 | 9-2 |
| Ammonium 2 | 5.0 | 10.0 | — |
| Ammonium 3 | 5.0 | — | 10.0 |

<Evaluation>

[Measurement of Volume Resistivity]

On each of the electrophotographic belts according to the above Examples, Reference Examples and Comparative Examples, the volume resistivity ρv was measured in the following way. Specifically, a value of the volume resistivity was defined as an average value of values obtained by measurements of 58 points at 20 mm intervals for each electrophotographic belt having a peripheral length of 1147 mm. The volume resistivity was measured according to Japanese Industrial Standards (JIS) K6271-1: 2015 “Rubber, vulcanized or thermoplastic—Determination of resistivity—Part 1: Guarded-electrode system” with the use of a high resistivity meter (trade name: Hiresta MCP-HT450, manufactured by Nittoseiko Analytech Co., Ltd.). As an electrode, a “UR probe” was used, and a value at the time when a voltage of 100 V was applied for 10 seconds was used. For information, the measurement was carried out in an environment at a temperature of 25° C. and a relative humidity of 55%.

[Evaluation of Effect of Lowering Resistance]

An effect of lowering the volume resistivity in each Example was evaluated by comparison with each of measurement results of each corresponding Reference Example. Specifically, the values were evaluated according to the following criteria, which were each obtained by subtracting the common logarithm value LOG(P) of the measured value P of the volume resistivity in each Example, from the common logarithm value LOG(Q) of the smallest measured value Q among the measured values of the volume resistivity of two or three Reference Examples corresponding to each Example.

(Evaluation Criteria for Lowering of Resistance)

Rank A: (LOG(Q)−LOG(P)≥4).

Rank B: (0.4>LOG(Q)−LOG(P)≥1).

Rank C: (LOG(Q)−LOG(P)<0.1).

The above evaluation results are shown in Tables 3-1 to 3-6. For information, in Tables 3-1 to 3-6, X represents the number of moles of the first cation, and Y represents the number of moles of the second cation. However, in Comparative Example 1 and Reference Examples 9-1 and 9-2, the first cation was not used, and accordingly the number of moles of ammonium 2 was set to X, and the number of moles of ammonium 3 was set to Y.

TABLE 3-1

| | | | | | | | Reference | Reference |
|---|---|---|---|---|---|---|---|---|
| Example/Reference | | Example | Example | Example | Example | Example | Example | Example |
| Example | | 1-1 | 1-2 | 1-3 | 1-4 | 1-5 | 1-1 | 1-2 |
| X/(X + Y) | | 0.8 | 0.7 | 0.5 | 0.3 | 0.2 | 1.0 | 0.0 |
| Volume resistivity pv | | 4.3 × 10¹⁰ | 1.3 × 10¹⁰ | 6.8 × 10⁹ | 9.8 × 10⁹ | 2.5 × 10¹⁰ | 3.5 × 10¹¹ | 6.8 × 10¹⁰ |
| [Ω · cm] | | | | | | | | |
| LOG(ρV) | | 10.6 | 10.1 | 9.8 | 10.0 | 10.4 | 11.5 | 10.8 |
| Evaluation of | LOG(Q) − LOG(P) | 0.2 | 0.7 | 1.0 | 0.8 | 0.4 | — | — |
| effect of | Evaluation rank | B | A | A | A | A | — | — |
| lowering | | | | | | | | |
| resistance | | | | | | | | |

TABLE 3-2

| | | | | | Reference | Reference | | Reference | Reference |
|---|---|---|---|---|---|---|---|---|---|
| Example/Reference | | Example | Example | Example | Example | Example | Example | Example | Example |
| Example | | 2-1 | 2-2 | 2-3 | 2-1 | 2-2 | 3 | 3-1 | 3-2 |
| X/(X + Y) | | 0.7 | 0.5 | 0.3 | 1.0 | 0.0 | 0.7 | 1.0 | 0.0 |
| Volume resistivity pv | | 3.9 × 10¹⁰ | 3.3 × 10¹⁰ | 3.8 × 10¹⁰ | 3.5 × 10¹¹ | 1.0 × 10¹¹ | 5.8 × 10¹⁰ | 3.5 × 10¹¹ | 1.5 × 10¹¹ |
| [Ω · cm] | | | | | | | | | |
| LOG(ρV) | | 10.6 | 10.5 | 10.6 | 11.5 | 11.0 | 10.8 | 11.5 | 11.2 |
| Evaluation | LOG(Q) − | 0.4 | 0.5 | 0.4 | — | — | 0.4 | — | — |
| of effect of | LOG(P) | | | | | | | | |
| lowering | Evaluation | A | A | A | — | — | A | — | — |
| resistance | rank | | | | | | | | |

TABLE 3-3

| | | | Reference | Reference | | Reference | Reference |
|---|---|---|---|---|---|---|---|
| Example/ | | Example | Example | Example | Example | Example | Example |
| Reference Example | | 4 | 4-1 | 4-2 | 5 | 5-1 | 5-2 |
| X/(X + Y) | | 0.3 | 1.0 | 0.0 | 0.5 | 1.0 | 0.0 |
| Volume resistivity pv | | 7.3 × 10¹⁰ | 6.3 × 10¹¹ | 1.5 × 10¹¹ | 1.3 × 10¹¹ | 3.5 × 10¹¹ | 1.2 × 10¹² |
| [Ω · cm] | | | | | | | |
| LOG(ρV) | | 10.9 | 11.8 | 11.2 | 11.1 | 11.5 | 12.1 |
| Evaluation of effect | LOG(Q) − LOG(P) | 0.3 | — | — | 0.4 | — | — |
| of lowering | Evaluation rank | B | — | — | A | — | — |
| resistance | | | | | | | |

TABLE 3-4

| | | | | Reference | Reference | | | Reference | Reference |
|---|---|---|---|---|---|---|---|---|---|
| Example/ | | Example | Example | Example | Example | Example | Example | Example | Example |
| Reference Example | | 6-1 | 6-2 | 6-1 | 6-2 | 7-1 | 7-2 | 7-1 | 7-2 |
| X/(X + Y) | | 0.5 | 0.3 | 1.0 | 0.0 | 0.7 | 0.3 | 1.0 | 0.0 |
| Volume resistivity pv | | 1.2 × 10¹¹ | 1.8 × 10¹¹ | 3.6 × 10¹² | 7.1 × 10¹¹ | 2.5 × 10¹⁰ | 1.9 × 10¹⁰ | 2.9 × 10¹¹ | 8.2 × 10¹⁰ |
| [Ω · cm] | | | | | | | | | |
| LOG(ρV) | | 11.1 | 11.3 | 12.6 | 11.9 | 10.4 | 10.3 | 11.5 | 10.9 |
| Evaluation of | LOG(Q) − LOG(P) | 0.8 | 0.6 | — | — | 0.5 | 0.6 | — | — |
| effect of | Evaluation rank | A | A | — | — | A | A | — | — |
| lowering | | | | | | | | | |
| resistance | | | | | | | | | |

TABLE 3-5

| | | | Reference | Reference | Reference |
|---|---|---|---|---|---|
| | | Example | Example | Example | Example |
| Example/Reference Example | | 8 | 8-1 | 8-2 | 8-3 |
| X/(X + Y) | | 0.3 | 1.0 | 0.0 | 0.0 |
| Volume resistivity pv | | 3.2 × 10¹⁰ | 8.0 × 10¹¹ | 3.4 × 10¹¹ | 2.5 × 10¹¹ |
| [Ω · cm] | | | | | |
| LOG(pv) | | 10.5 | 11.9 | 11.5 | 11.4 |
| Evaluation of effect | LOG(Q)-LOG(P) | 0.9 | — | — | — |
| resistance | Evaluation rank | A | — | — | — |
| of lowering | | | | | |

TABLE 3-6

| | | | Reference | Reference |
|---|---|---|---|---|
| Comparative Example/ | | Comparative | Example | Example |
| Reference Example | | Example 1 | 9-1 | 9-2 |
| X/(X + Y) | | 0.5 | 1.0 | 0.0 |
| Volume resistivity pv | | 8.2 × 10¹⁰ | 1.0 × 10¹¹ | 6.8 × 10¹⁰ |
| [Ω · cm] | | | | |
| LOG(pv) | | 10.9 | 11.0 | 10.8 |
| Evaluation | LOG(Q)-LOG(P) | −0.1 | — | — |
| of effect | Evaluation rank | C | — | — |
| resistance | | | | |
| of lowering | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-131871, filed Aug. 13, 2021, and Japanese Patent Application No. 2022-109879, filed Jul. 7, 2022, which are hereby incorporated by reference herein in their entirety.

What is claimed is:

1. An electrophotographic member comprising a base layer and an elastic layer on the base layer, wherein
the elastic layer comprises
a silicone rubber,
at least one first cation selected from the group consisting of a cation represented by the following Structural Formula (1-1) and a cation represented by the following Structural Formula (1-2),
at least one second cation selected from the group consisting of a cation represented by the following Structural Formula (2-1) and a cation represented by the following Structural Formula (2-2), and
an anion: 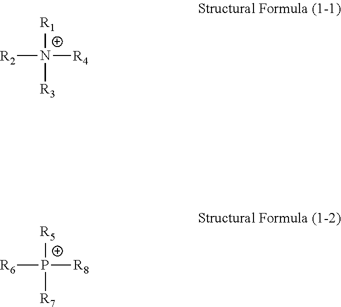
wherein R₁ to R₈ each independently represent an alkyl group having 1 to 14 carbon atoms, provided that at least three of the alkyl groups represented by R₁ to R₄ and at least three of the alkyl groups represented by R₅ to R₈ have a straight-chain portion having 6 or more carbon atoms, 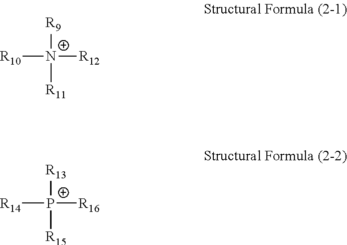
wherein R₉ to R₁₆ each independently represent an alkyl group having 1 to 4 carbon atoms.

2. The electrophotographic member according to claim 1, wherein the anion is at least one member selected from the group consisting of F⁻, Cl⁻, Br⁻, I⁻, NO₃⁻, BF₄⁻, PF₆⁻, AsF₆⁻, SbF₆⁻, CH₃COO⁻, CF₃COO⁻, (C₂F₅)₃PF₃⁻, CₙF₂ₙ₊₁SO₃⁻, and (CₘF₂ₘ₊₁SO₂)(CₙF₂ₙ₊₁SO₂)N⁻, wherein m and n each independently represent an integer of 0 to 4.

3. The electrophotographic member according to claim 2, wherein the anion is an anion represented by the following Structural Formula (3):

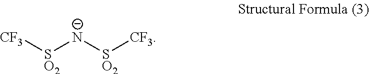 [SMILES: O=S(=O)([N-]S(=O)(=O)C(F)(F)F)C(F)(F)F]

4. The electrophotographic member according to claim 1, wherein all of the alkyl groups represented by R₁ to R₄ are not the same alkyl groups, and all of the alkyl groups represented by R₅ to R₈ are not the same alkyl groups.

5. The electrophotographic member according to claim 4, wherein three of the alkyl groups represented by R₁ to R₄ have a straight-chain portion having 6 or more carbon atoms and the other one does not have a straight-chain portion having 6 or more carbon atoms, and three of the alkyl groups represented by R₅ to R₈ have a straight-chain portion having 6 or more carbon atoms and the other one does not have a straight-chain portion having 6 or more carbon atoms.

6. The electrophotographic member according to claim 1, wherein X/(X+Y) is 0.2 to 0.7, where X represents the number of moles of the first cation contained in the elastic layer and Y represents the number of moles of the second cation.

7. The electrophotographic member according to claim 1, wherein a total amount of the first cation and the second cation is 0.3 to 18 mmol based on 100 g of the silicone rubber contained in the elastic layer.

8. The electrophotographic member according to claim 1, wherein the elastic layer is a cured product of an addition curing type liquid silicone rubber mixture comprising an addition curing type liquid silicone rubber, the first cation, the second cation, and the anion.

9. The electrophotographic member according to claim 1, wherein the electrophotographic member is an electrophotographic belt having an endless belt shape.

10. An electrophotographic image forming apparatus comprising an intermediate transfer member, the intermediate transfer member comprising an electrophotographic member having a base layer and an elastic layer on the base layer, wherein
the elastic layer comprises
a silicone rubber,
at least one first cation selected from the group consisting of a cation represented by the following Structural Formula (1-1) and a cation represented by the following Structural Formula (1-2),
at least one second cation selected from the group consisting of a cation represented by the following Structural Formula (2-1) and a cation represented by the following Structural Formula (2-2), and
an anion: 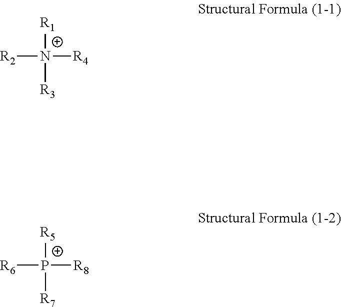
wherein R₁ to R₈ each independently represent an alkyl group having 1 to 14 carbon atoms, provided that at least three of the alkyl groups represented by R₁ to R₄ and at least three of the alkyl groups represented by R₅ to R₈ have a straight-chain portion having 6 or more carbon atoms; 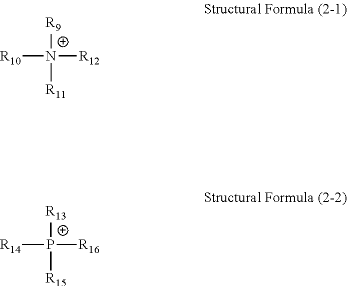
wherein R₉ to R₁₆ each independently represent an alkyl group having 1 to 4 carbon atoms.
